(19) United States
(12) Patent Application Publication
(10) Pub. No.: US 2025/0130658 A1
(43) Pub. Date: Apr. 24, 2025

(54) DISPLAY DEVICE

(71) Applicant: LS ELECTRIC CO., LTD., Anyang-si, Gyeonggi-do (KR)

(72) Inventor: Sang Oh JOO, Anyang-si, Gyeonggi-do (KR)

(21) Appl. No.: 18/725,941

(22) PCT Filed: Apr. 24, 2023
(86) PCT No.: PCT/KR2023/005571

§ 371 Date: Jul. 1, 2024

(30) Foreign Application Priority Data
Jun. 3, 2022 (KR) 10-2022-0068123

(51) Int. Cl. G06F 3/041

(52) U.S. Cl. CPC G06F 3/0412

(57) ABSTRACT

The present disclosure relates to a display device which may comprise: a main frame for fixing a touchscreen panel and a display part; a cover part coupled to the rear side of the main frame so as to seal the rear side of the touchscreen panel and the display part, and enabling cable of the touchscreen panel and the display part to be exposed to the outside while maintaining the sealed state; and a controller coupled to a portion of the rear of the cover part and connected to the cable.

### TECHNICAL FIELD

The present disclosure relates to a display device, and more particularly, to a display device that is capable of suppressing an inflow of moisture, gas, or foreign substances.

### BACKGROUND ART

In general, flat display devices are widely used not only in devices encountered in everyday life such as TVs, smartphones, and monitors, but also in industrial devices.

Also, recently, touch screen panels that allow direct input through display devices without separate input devices are being applied to industrial devices.

A touch screen panel usually includes an upper plate and a lower plate, each of which typically has a transparent electrode. When the user presses the touch screen panel with a finger or pen, a contact position of the transparent electrode is transmitted to a controller.

The controller outputs recognized coordinates. The user's touch is determined as an input of a control command by driver software, etc.

In the related art display device, a space exists between a touch screen panel and a display. If gas or foreign substances containing nitrogen are introduced from outside into the space between the touch screen panel and the display, there is a problem that discoloration or a decrease in brightness may occur.

In consideration of this problem, in Korean Patent Laid-open Application No. 10-2015-0071532 (published on Jun. 26, 2015, Display device having gap maintenance part), a cell seal is formed between the touch screen panel and the display to suppress an introduction of external air or foreign substances.

However, in order to provide a sealing structure such as the cell seal, there were disadvantages in that the cost increased and it took a long time to assembly the structure.

Unlike general home display devices, an industrial display device is combined with a controller that transmits a control command input through a touch screen panel to other industrial equipment, and the structure of the display device is also different from the general display devices.

Hereinafter, the structure of the related art industrial display device will be described in more detail.

FIG. 1 is a cross-sectional diagram illustrating one embodiment of a display device according to the related art.

Referring to FIG. 1, the related art display device 100 is installed in an opening of a panel 200 of equipment.

The related art display device 100 includes a main frame 110 fixed to the panel 200, a touch screen panel 120 fixed to the main frame 110, a display 130 disposed inside the main frame 110 to display a screen, a controller 140 for controlling the touch screen panel 120 and the display 130, a heat sink 141 for dissipating heat generated from the controller 140, and a cover part 150 for covering the rear surface of the main frame 110 to accommodate the display 130, the controller 140, and the heat sink 141.

The related art display device 100 configured in this way can be understood as a schematic configuration to explain the problems of the related art display device.

First, the main frame 110 is a square window frame and is installed on the panel 200 of industrial equipment where the display device is installed.

An opening is formed through the panel 200 and a portion of the main frame 110 may be inserted into the opening. The portion of the main frame 110 inserted into the opening is fixed to the panel 200. Since the area of the front surface of the main frame 110 is larger than the area of the opening formed through the panel 200, the main frame 100 is not fully inserted into the opening.

FIG. 2 is a partially enlarged view of the main frame 110.

The main frame 110 includes an insertion portion 113 that is inserted into the opening of the panel 200 and extends toward the rear surface. A locking portion 115 has a structure that extends outward to be in contact with the front surface of the panel 200.

In addition, an installation surface 114 on which the touch screen panel 120 and the display 130 may be fixedly installed is formed by extending toward a center of the main frame 110 which is opposite to the locking portion 115.

An edge of the rear surface of the touch screen panel 120 may be fixed to the front side of the installation surface 114 by use of an adhesion member 111 such as a double-sided tape, and an edge of the front side of the display 130 may be fixed to the rear side of the installation surface 114.

Referring back to FIG. 1, the controller 140 is located on the rear side of the display 130 to check a screen displayed on the display 130 and coordinates input through the touch screen panel 120, and interpret a user's command.

The controller 140 generates heat during operation, and the generated heat may deteriorate the display 130 and the controller 140, so heat dissipation is required.

In the related art structure, heat generated during the operation of the controller 140 may be dissipated by the heat sink 141, and a vent hole 152 is formed through the cover part 150 to facilitate heat dissipation.

That is, external air is allowed to flow in through the vent hole 152, to exchange heat with the heat sink 141, thereby dissipating heat of the controller 140.

An opening and closing portion 151 through which internal structures may be confirmed and controlled may be formed on a portion of the cover part 150.

In this way, the vent hole 152 is formed through the cover part 150 of the related art display device 100, which facilitates the dissipation of the heat generated from the controller 140. However, external air and foreign substances may flow into the cover part 150 through the vent hole 152. If nitrogen or foreign substances contained in external air flow into a space between the display 130 and the touch screen panel 120 and the rear surface of the display 130, it may cause discoloration of the display 130, and may cause a decrease in brightness of the display device 100.

In order to suppress this problem, it is essential to seal the display 130 and the main frame 110 using a sealing member such as silicon to suppress the introduction of external air or foreign substances.

Therefore, according to the related art, there were problems that the manufacturing cost of the display device 100 increased and a time required for an assembly process also increased unnecessarily.

In addition, when a sealing operation using a sealing member was performed manually, a failure of complete sealing was likely to occur due to an operator's error, leading to a problem of reducing reliability.

### DISCLOSURE OF INVENTION

### Technical Problem

An aspect of the present disclosure is to provide a display device that is capable of suppressing an introduction of external air and foreign substances without using a sealing member such as silicon.

Another aspect of the present disclosure is to provide a display device that is capable of blocking an introduction of foreign substances by using a buffer PCB, rather than directly connecting cables of a touch screen panel and a display to a connector.

### Solution to Problem

To achieve those aspects and other advantages, a display device according to one aspect of the present disclosure may include a main frame that fixes a touch screen panel and a display, a cover part that is coupled to a rear side of the main frame to seal a rear side of the touch screen panel and the display, and allows cables of the touch screen panel and the display to be externally exposed while maintaining a sealed state, and a controller that is coupled to a portion of a rear surface of the cover part and connected to the cables.

In an embodiment of the present disclosure, the cover part may include an opening formed through the rear surface thereof, a gasket disposed on a periphery of the opening, and a buffer printed circuit board (PCB) that seals the opening where the gasket is disposed, and connects an inner cable and an external cable.

In an embodiment of the present disclosure, the main frame may include a gasket that is in contact with a front surface of a panel of a target facility on which the main frame is to be installed.

In an embodiment of the present disclosure, the main frame may be brought into close contact with the front surface of the panel by a plurality of fastening parts.

In an embodiment of the present disclosure, the fastening part may include a body that has a pressing plate in contact with a rear surface of the panel, and a supporting plate located with being spaced apart from the pressing plate and supporting rotation of a bolt, and a movable plate that moves along with the rotation of the bolt with a portion of the body being inserted therein.

In an embodiment of the present disclosure, the movable plate may be partially exposed to an open surface of the body and inserted into a groove disposed in a side surface of the cover part, and the exposed portion may be bent and coupled to the cover part as the movable plate moves along with the rotation of the bolt.

In an embodiment of the present disclosure, the main frame may further include an accommodating part that accommodates the display therein, and the cover part may be fastened to the accommodating part.

### Advantageous Effects of Invention

According to the present disclosure, a display device can be easily installed on a panel of a target facility, on which the display device is to be installed, while maintaining a sealed state. In addition, external gas or foreign substances can be suppressed from entering a display, thereby suppressing deterioration of the display device such as a decrease in brightness.

More specifically, in the present disclosure, a controller may be disposed outside a cover part, and thus a vent hole for dissipating heat of the controller, which acts as a heat source, does not need to be formed through a cover part. Accordingly, inside and outside of the cover part can be completely sealed from each other, thereby suppressing deterioration such as a decrease in brightness due to external air or foreign substances.

In addition, according to the present disclosure, when installing a display device, hermetic sealing can be maintained in a panel of a target facility on which the display device is to be installed, and a means for easy installation can be disposed, thereby providing a structure which is easily installed and more stable.

### BRIEF DESCRIPTION OF DRAWINGS

FIG. 1 is a cross-sectional diagram illustrating one embodiment of a display device according to the related art.

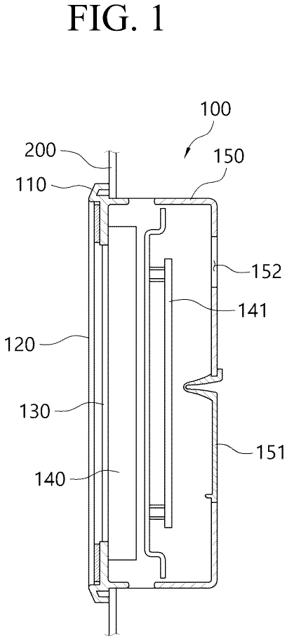

FIG. 2 is a partially enlarged view of a main frame of FIG. 1.

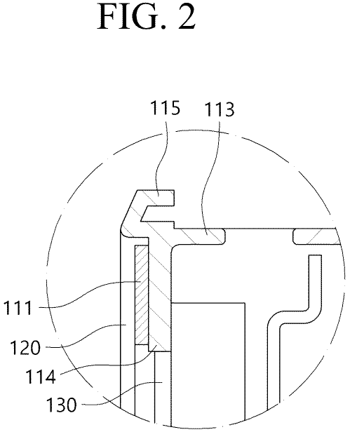

FIG. 3 is a perspective view illustrating the display device according to one embodiment.

FIG. 4 is a cross-sectional diagram illustrating the display device according to one embodiment.

FIG. 5 is a partially enlarged cross-sectional diagram illustrating the display device according to one embodiment.

FIG. 6 is a perspective view illustrating a cover part of the display device according to one embodiment.

FIG. 7 is a partially cross-sectional view of the cover part.

### MODE FOR THE INVENTION

In order to fully understand the structure and effects of the present disclosure, the preferred embodiments of the present disclosure will be described with reference to the accompanying drawings. However, the present disclosure is not limited to the embodiments described below, but may be implemented in various forms modifications. The embodiments disclosed herein are merely illustrative to help understanding the present disclosure and fully inform of the scope of the present disclosure to those skilled in the art that the present disclosure pertains. In the accompanying drawings, constituent elements are enlarged in size for the convenience of explanation, and the proportions of the constituent elements may be exaggerated or reduced.

It will be understood that although the terms first, second, etc. may be used herein to describe various elements, these elements should not be limited by these terms. These terms are generally only used to distinguish one element from another. For example, ‘first component’ may be referred to as ‘second component’, and similarly, the ‘second component’ may also be referred to as the ‘first component’, without departing from the scope of the present disclosure. Also, a singular representation may include a plural representation unless it represents a definitely different meaning from the context. The terms used in the embodiments of the present disclosure may be construed as commonly known to those skilled in the art unless otherwise defined.

Hereinafter, a display device according to one embodiment of the present disclosure will be described in detail with reference to the drawings.

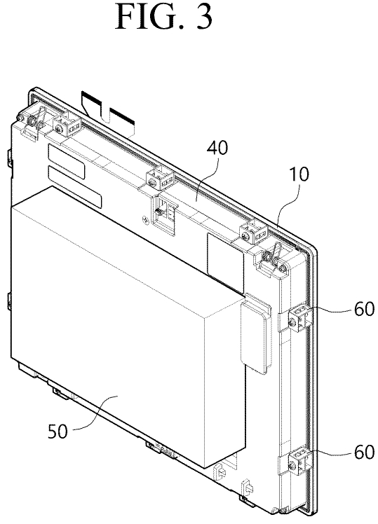

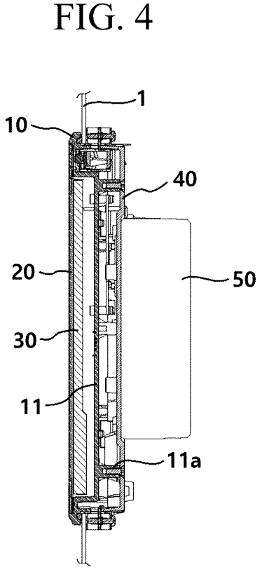

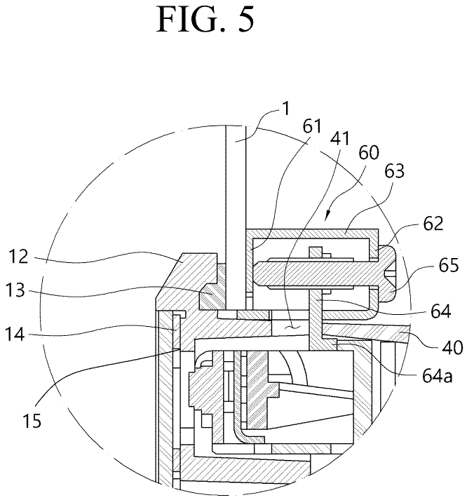

FIG. 3 is a perspective view illustrating a display device according to one embodiment, FIG. 4 is a cross-sectional diagram illustrating the display device according to one embodiment, and FIG. 5 is a partially enlarged view of the main part of FIG. 4.

Referring to FIGS. 3 to 5, a display device according to one embodiment includes a main frame 10 fixed to a panel 1, a touch screen panel 20 fixed to the main frame 10, a display 30 that displays a screen inside the main frame 10, a cover part 40 that covers the display 30 on a rear surface of the main frame 10, a controller 50 coupled to an outer rear surface of the cover part 40 to control the display 30 and perform input and analysis of coordinates through the touch screen panel 20, and a fastening part 60 disposed in plurality on a side surface of the cover part 40 to fix the main frame 10 to the panel 1 in a close contact manner.

Hereinafter, the configuration and operation of the display device according to one embodiment described above will be described in more detail.

First, the display device according to one embodiment is fixedly installed on the panel 1 of a facility (i.e., target facility) on which the display device is to be installed.

The target facility includes a panel 1 that has an opening into which the display device is inserted and is exposed to outside.

The main frame 10 may be a window frame. An accommodating part 11 for accommodating and fixing the display 30 may be formed inside the main frame 10.

The accommodating part 11 may be formed in a shape of a plate. A through hole may be formed through the accommodating part 11, and cables of the display 30 and the touch screen panel 20 may pass through the through hole.

A protrusion 12 may be formed on a periphery of the main frame 10 to be in contact with an outer surface of the front side of the panel 1. A gasket 13 is located between the protrusion 12 and the panel 1.

The operation of the gasket 13 and a close-contact coupling structure between the protrusion 12 and the panel 1 will be described in more detail later.

An adhesive surface 15 on which the touch screen panel 20 may be adhered is formed on the main frame 10. The adhesive surface 15 and the touch screen panel 20 may be fixed by an adhesive means 14 such as a double-sided tape or the like.

The adhesive surface 15 may extend from the inside of the protrusion 12 and may have a flat surface.

The display 30 that displays a screen is located on the rear surface side of the touch screen panel 20. The display 30 may be partially spaced apart from the touch screen panel 20 or may be laminated with the touch screen panel 20.

The touch screen panel 20 may have a larger area than the display 30. The display 30 laminated on the rear surface of the touch screen panel 20 is accommodated in the accommodating part 11.

The accommodating part 11 may not have a hermetic structure. Although omitted in the drawings, a through hole may be formed through the accommodating part 11. Cables of the touch screen panel 20 and the display 30 may pass through the through hole formed through the accommodation part 11 and be exposed to the cover part 40.

Grooves 41 to which a plurality of fastening parts 60 are coupled may be formed in side surfaces of the cover part 40. The grooves 41 may be formed at positions spaced apart from one another along a periphery of the cover part 40. The grooves 41 may have a slit shape.

In the drawing, the groove 41 has a structure that communicates the inside and outside of the cover part 40 with each other. However, in another embodiment, a region of the cover part 40 corresponding to the inside of the groove 41 may be shielded. Accordingly, the inside and outside may be blocked from each other by the groove 41 with respect to the cover part 40.

Each of the fastening parts 60 includes a body 63 that has one surface and another surface acting as a pressing plate 61 and a supporting plate 62, respectively, and a movable plate 64 that protrudes from an open surface side of the body 63 to be inserted into the groove 41, and is provided with a bent portion 64a formed on an end thereof to fix the body 63 to the cover part 40 during movement when a bolt 65 is turned.

The configuration of the fastening part 60 having this structure will be described in more detail.

The pressing plate 61 and the supporting plate 62 are located in parallel with being spaced apart from each other. The pressing plate 61 may be in contact with an inner surface of the panel 1 at the time of installation.

In this instance, the open surface of the body 63 may be disposed to be in contact with the groove 41 formed in the side surface of the cover part 40. Accordingly, the movable plate 64 is inserted into the groove 41. The bent portion 64a of the movable plate 64 may be bent in a direction toward the supporting plate 62.

An insertion hole into which the bolt 65 is inserted is formed in a portion of the movable plate 64.

Accordingly, as the bolt 65 is fastened, the movable plate 64 moves in a direction toward the supporting plate 62, and the bent portion 64a is caught on the inner surface of the cover part 40 such that the body 63 is fixed to the cover part 40.

In addition, an insertion hole into which the bolt 65 is inserted is formed in the supporting plate 62, and the pressing part 61 does not have an insertion hole into which the bolt 65 is inserted. Therefore, when the bolt 65 is turned to be fastened to the supporting plate 62 while being supported by the supporting plate 62, fastening pressure of the bolt 65 may act in a direction toward the panel 1 by the pressing plate 61.

As the bolt 65 is fastened in this way, the touch screen panel 20 is firmly adhered on the panel 1 by pressure acting on the end of the bolt 65.

At this time, the gasket 13 described above is located on the opposite side of the panel 1, and thus a hermetic structure in which the inside and the outside of the panel 1 are completely separated can be obtained.

Additionally, the main frame 10 can be firmly fixed to the panel 1 merely by fastening the bolt 65 to the fastening part 60.

FIG. 3 illustrates an embodiment in which a surface of the body 63 in contact with the cover part 40 and a surface facing the surface are open. However, as illustrated in FIG. 5, in order to suppress the introduction of external air and foreign substances, only a portion of a surface of the body 63 that is in contact with the cover part 40 may be open to enable the movement of the movable plate 64.

In addition to being fastened by the fastening part 60, the cover part 40 may be fastened to the main frame 10 with bolts.

More specifically, a fastening portion 11a for bolt fastening may protrude from the rear surface of the accommodating part 11. A bolt may be fastened to the fastening portion 11a from the rear surface of the cover part 40, such that the main frame 10 and the cover part 40 can be firmly coupled to each other.

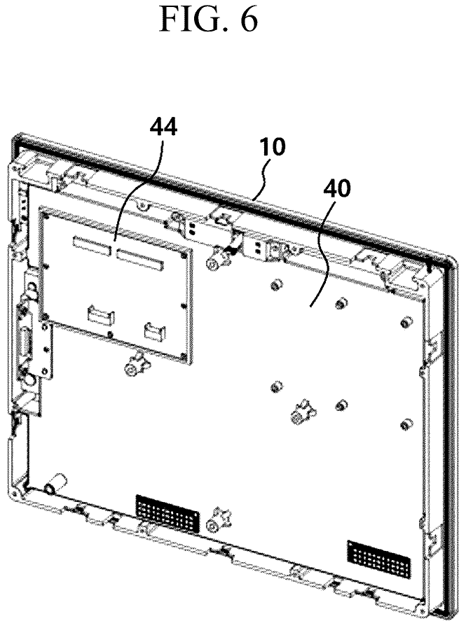

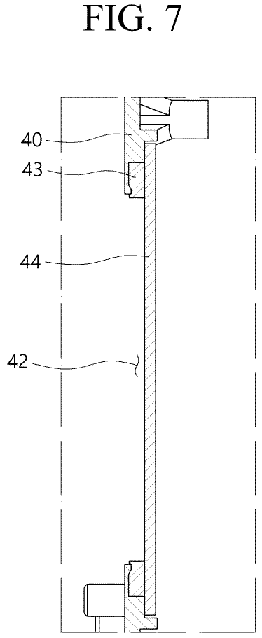

FIG. 6 is a perspective view of the cover part 40, and FIG. 7 is a partial cross-sectional view of the cover part 40.

As described above, the controller 50 is coupled to the rear surface of the cover part 40.

In addition, cables for signal transmission to the touch screen panel 20 and the display 30 must be connected to the controller 50.

An opening 42 for connecting the cables may be formed through the cover part 40 to connect the cable.

However, the opening 42 may be a passage through which external gas and foreign substances may be introduced. Therefore, the introduction of the external air or foreign substances can be suppressed by sealing the opening 42.

Specifically, the opening 42 may be sealed using the gasket 43 and a buffer PCB 44 to suppress foreign substances and external gases from flowing into the space formed by the cover part 40 and the main frame 10.

The buffer PCB 44 may include connectors to which cables are coupled on at least both surfaces, and the connectors coupled to the both surfaces may be electrically connected to other devices.

That is, a connector that is located on one surface of the buffer PCB 44 on the front side of the cover part 40 may receive an electrical signal from the touch screen panel 20 or provide data to be displayed on the display 30 through the cable.

In addition, a connector that is located on another surface of the buffer PCB 44 on the rear side of the cover part 40 may be connected to the controller 50.

With this configuration, the controller 50 can be located outside the cover part 40, and the airtightness of the cover part 40 can be maintained, thereby completely blocking the introduction of external air and foreign substances into the space formed by the cover part 40 and the main frame 10.

In particular, since the controller 50 acts as a heat source during operation, a vent hole for heat dissipation is absolutely necessary when the controller 50 is disposed inside the cover part 40. However, according to the foregoing embodiments, since the controller 50, which is a heat source, is disposed outside the cover part 40, there is no need to form a vent hole through the cover part 40.

This can result in completely blocking external air and foreign substances from entering the space formed by the cover part 40 and the main frame 10. Additionally, since external air and foreign substances do not enter the space formed by the cover part 40 and the main frame 10, deterioration of the display device can be suppressed.

In addition, according to the foregoing embodiment, since the gasket 13 is disposed between the main frame 10 and the panel 1, and the main frame 10 and the panel 1 are fixedly pressed by using the fastening parts 60, the inside and outside of the target facility can be completely separated.

The foregoing embodiments according to the present disclosure are merely illustrative, and it will be understood by those skilled in the art that various changes and modifications can be made without departing from the spirit and scope of the invention as defined by the appended claims. Therefore, the technical scope of the present disclosure should be determined by the following claims.

1. A display device comprising:
a main frame that fixes a touch screen panel and a display;
a cover part that is coupled to a rear side of the main frame to seal a rear side of the touch screen panel and the display, and allows a cable of the touch screen panel and the display to be externally exposed while maintaining a sealed state; and
a controller that is coupled to a portion of a rear surface of the cover part and connected to the cable.

2. The display device of claim 1, wherein the cover part comprises:
an opening formed through the rear surface thereof;
a gasket disposed on a periphery of the opening; and
a buffer printed circuit board (PCB) that seals the opening where the gasket is disposed, and connects an inner cable and an external cable.

3. The display device of claim 1, wherein the main frame comprises a gasket that is in contact with a front surface of a panel of a target facility on which the main frame is to be installed.

4. The display device of claim 3, wherein the main frame is brought into close contact with the front surface of the panel by a plurality of fastening parts.

5. The display device of claim 4, wherein the fastening part comprises:
a body that has a pressing plate in contact with a rear surface of the panel, and a supporting plate located with being spaced apart from the pressing plate and supporting rotation of a bolt; and
a movable plate that moves along with the rotation of the bolt with a portion of the body being inserted therein.

6. The display device of claim 5, wherein the movable plate is partially exposed to an open surface of the body and inserted into a groove disposed in a side surface of the cover part, and
the exposed portion is bent and coupled to the cover part as the movable plate moves along with the rotation of the bolt.

7. The display device of claim 1, wherein the main frame further comprises an accommodating part that accommodates the display therein,
the cover part is fastened to the accommodating part.
